(19) United States
(12) Patent Application Publication
(10) Pub. No.: US 2010/0302604 A1
(43) Pub. Date: Dec. 2, 2010

(54) SYSTEM AND METHOD FOR SETTING DATA EXTRACTION FIELDS FOR SCANNER INPUT

(76) Inventors: Marianne L. Kodimer, Huntington Beach, CA (US); Hongfeng (Jason) Wei, Cerritos, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/472,752

(22) Filed: May 27, 2009

(51) Int. Cl. H04N 1/04

(52) U.S. Cl. 358/474

(57) ABSTRACT

The subject application is directed to a system and method setting data extraction fields for scanner input. Electronic document image data is generated from a tangible document that has an associated predefined layout, and a corresponding image is generated on an associated display. A zone area is generated as a sub-portion disposed with the displayed image and positioning data is received that corresponds to a user-selected location of a zone area relative to the electronic document image. User-selected tag data associated with each zone area is received and stored associatively with positioning data in accordance with a document identifier corresponding to the tangible document in a data storage. Image data of tangible documents is generated, with each tangible document having the predefined layout. Character data is extracted from image data of each document according to positioning data and stored associatively with tag data in an associated database.

### BACKGROUND OF THE INVENTION

The subject application is directed generally to extraction of character data from tangible documents. The system is particularly suitable for use in setting up a template to allow users to quickly scan selected areas from standardized forms and relay extracted information to a database used in conjunction with a document management system.

Businesses rely on a continuous stream of information relative to tracking and managing orders, products, operations, shipments, inventory, billing, purchasing, and the like. Traditionally, much of this information was captured in one or more standardized forms, which would be manually read and relevant information humanly extracted and tabulated for future use.

More recently, there is increasing use of electronic documents, which do not require substantial space for storage, and which are more readily and widely accessible. However, there are still many situations that rely on tangible documents for information.

### SUMMARY OF THE INVENTION

In accordance with one embodiment of the subject application, there is provided a system and method for setting data extraction fields for scanner input. Electronic document image data is generated from an associated tangible document, the tangible document having a predefined layout associated therewith and a document image corresponding to the electronic document image data is generated on an associated display. At least one zone area is generated as a sub-portion disposed with the document image on the display and positioning data is received from an associated user, the positioning data being representative of a user-selected location of the at least one zone area relative to the electronic document image. User-selected tag data associated with each of the at least one zone areas is received and stored associatively with positioning data in accordance with a document identifier corresponding to the tangible document in a data storage. Image data corresponding to each of a plurality of tangible documents is generated, each of a plurality of tangible documents having the predefined layout associated therewith. Character data is extracted from image data corresponding to each of the plurality of tangible documents in accordance with stored positioning data and stored associatively with tag data corresponding thereto in an associated database.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for setting data extraction fields for scanner input according to one embodiment of the subject application;

FIG. 2 is a block diagram illustrating device hardware for use in the system for setting data extraction fields for scanner input according to one embodiment of the subject application;

FIG. 3 is a functional diagram illustrating the device for use in the system for setting data extraction fields for scanner input according to one embodiment of the subject application;

FIG. 4 is a block diagram illustrating controller hardware for use in the system for setting data extraction fields for scanner input according to one embodiment of the subject application;

FIG. 5 is a functional diagram illustrating the controller for use in the system for setting data extraction fields for scanner input according to one embodiment of the subject application;

FIG. 6 is a functional diagram illustrating a workstation for use in the system for setting data extraction fields for scanner input according to one embodiment of the subject application;

FIG. 7 is a functional diagram illustrating a server for use in the system for setting data extraction fields for scanner input according to one embodiment of the subject application;

FIG. 8 is a block diagram illustrating the system for setting data extraction fields for scanner input according to one embodiment of the subject application;

FIG. 9 is a functional diagram illustrating the system for setting data extraction fields for scanner input according to one embodiment of the subject application;

FIG. 10 is a flowchart illustrating a method for setting data extraction fields for scanner input according to one embodiment of the subject application;

FIG. 11 is a flowchart illustrating a method for setting data extraction fields for scanner input according to one embodiment of the subject application;

FIG. 12 is a screen shot illustrating a thin client display used in the system and method for setting data extraction fields for scanner input according to one embodiment of the subject application;

FIG. 13 is a screen shot illustrating a thin client display used in the system and method for setting data extraction fields for scanner input according to one embodiment of the subject application;

FIG. 14 is a screen shot illustrating a thin client display used in the system and method for setting data extraction fields for scanner input according to one embodiment of the subject application; and

FIG. 15 is a screen shot illustrating a thin client display used in the system and method for setting data extraction fields for scanner input according to one embodiment of the subject application.

### DETAILED DESCRIPTION OF THE PREFERRED EMBODIMENT

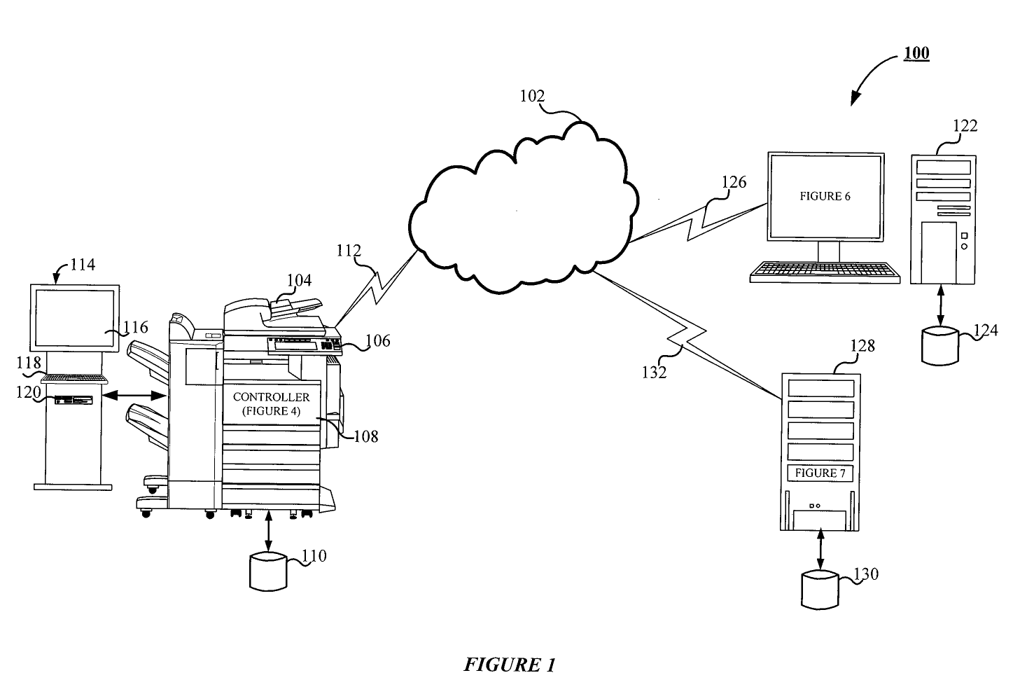

The subject application is directed to a system and method for extracting character data from tangible documents. In particular, the subject application is directed to a system and method for use in setting up a template to allow users to quickly scan selected areas from standardized forms and relay extracted information to a database used in conjunction with a document management system. More particularly, the subject application is directed to a system and method that is applicable to the setting of data extraction fields for scanner input. It will become apparent to those skilled in the art that the system and method described herein are suitably adapted to a plurality of varying electronic fields employing templates, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for setting data extraction fields for scanner input in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

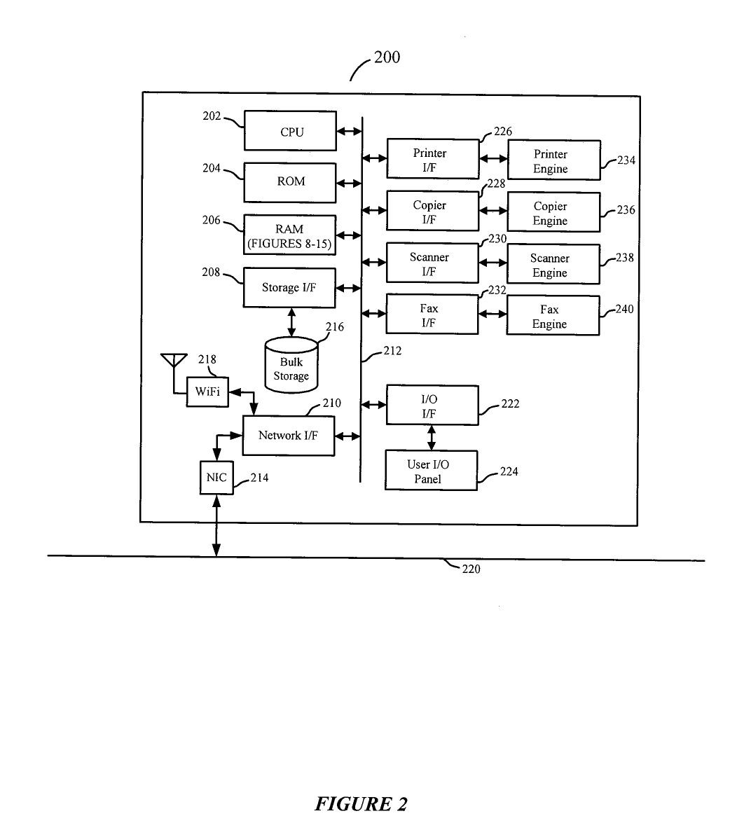

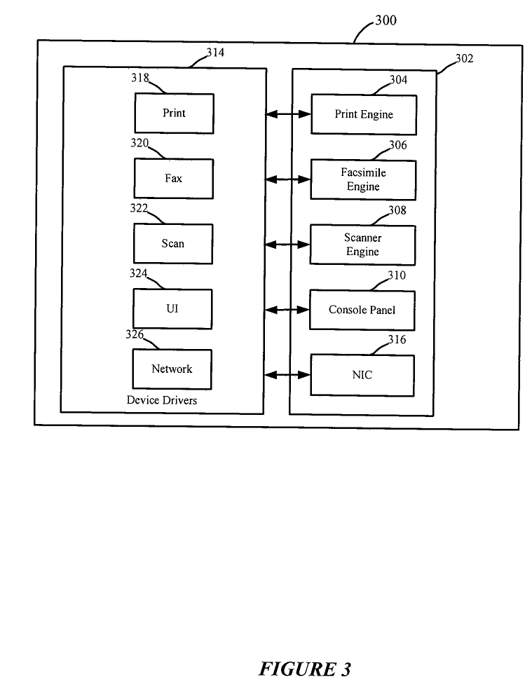

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

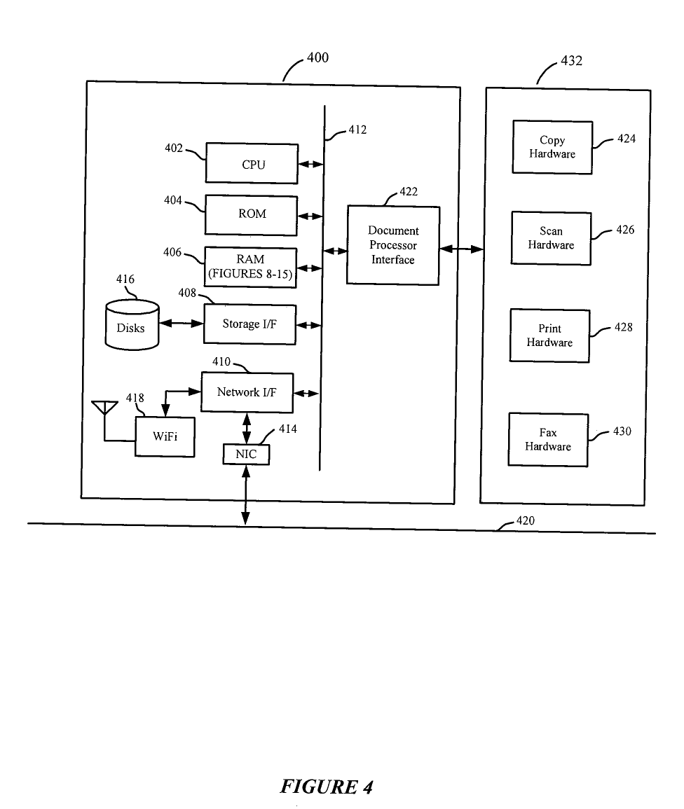

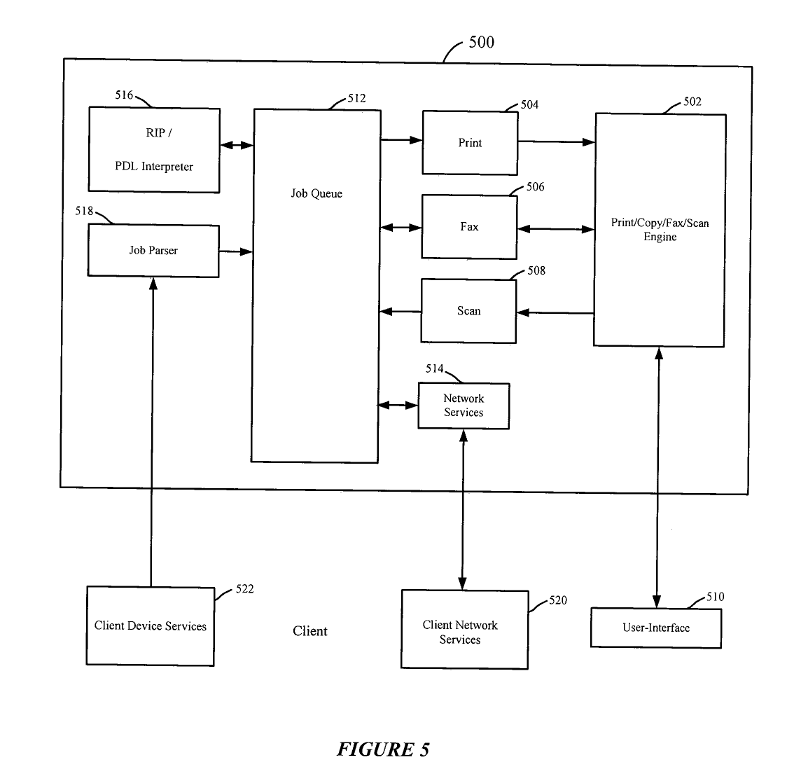

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for setting data extraction fields for scanner input of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is an administrative device, illustrated as an administrative computer workstation 122 in data communication with the computer network 102 via a communications link 126. It will be appreciated by those skilled in the art that the administrative workstation 122 is shown in FIG. 1 as a workstation computer for illustration purposes only. As will be understood by those skilled in the art, the administrative workstation 122 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the administrative workstation 122 further includes software, hardware, or a suitable combination thereof configured to interact with the document processing device 104, or the like.

Communicatively coupled to the administrative workstation 122 is the data storage device 124. According to one example embodiment of the subject application, the data storage device 124 is any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store account information, template data, electronic document data, electronic form data, scanned electronic image data, and the like. It will be appreciated by those skilled in the art that while illustrated in FIG. 1 as being a separate component of the system 100, the data storage device 124 is capable of being implemented as an internal storage component of the administrative workstation 122, or the like, such as, for example and without limitation, an internal hard disk drive, or the like.

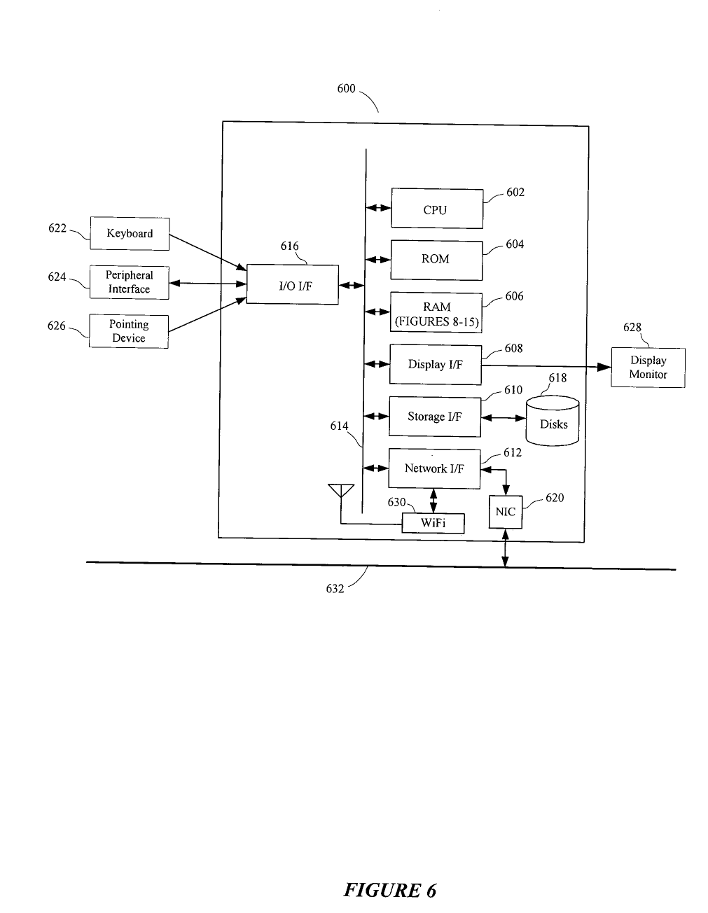

The communications link 126 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative workstation 122 is suitably adapted to provide document data, job data, user interface data, image data, monitor document processing jobs, employ thin-client interfaces, generate display data, generate output data, or the like, with respect to the document processing device 104, or any other similar device coupled to the computer network 102. The functioning of the administrative device 122 will better be understood in conjunction with the block diagram illustrated in FIG. 6, explained in greater detail below.

The system 100 illustrated in FIG. 1 further depicts a backend component, shown as the server 128, in data communication with the computer network 102 via a communications link 132. It will be appreciated by those skilled in the art that the server 128 is shown in FIG. 1 as a component of the system 100 for example purposes only, and the subject application is capable of implementation without the use of a separate backend server component, e.g. the server 128 is capable of implementation via the document processing device 104, or via an administrative device 122. The skilled artisan will appreciate that the server 128 comprises hardware, software, and combinations thereof suitably adapted to provide one or more services, web-based applications, storage options, and the like, to networked devices. In accordance with one example embodiment of the subject application, the server 128 includes various components, implemented as hardware, software, or a combination thereof, for managing retention of documents, text data, performing searches, comparisons, maintaining database entries, account information, receiving payment data, retrieval of documents, and the like, which are accessed via the computer network 102. A suitable example of such a server 128 includes, for example and without limitation, a device operable as a MICROSOFT SHAREPOINT SERVER, or the like.

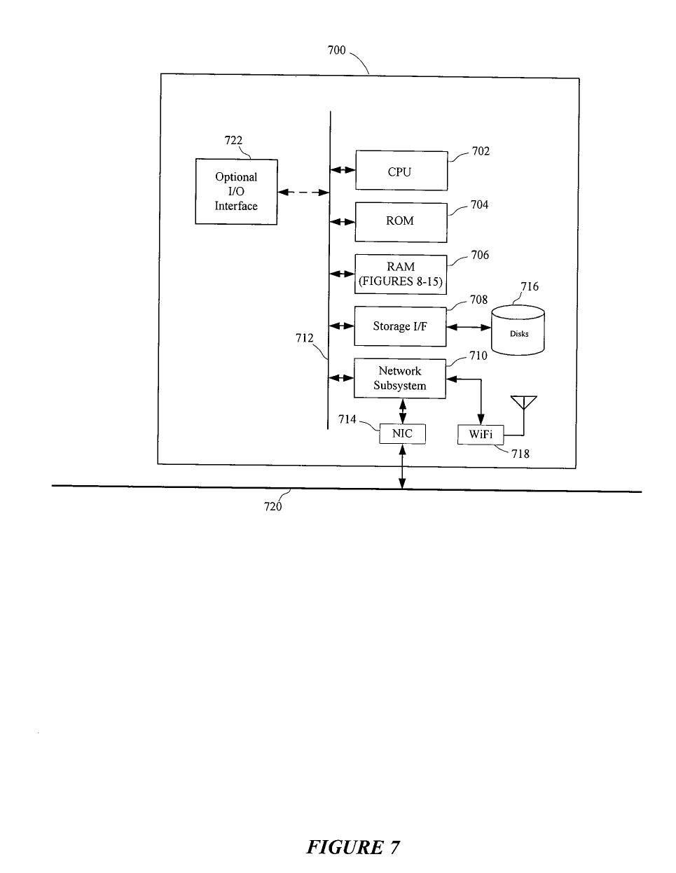

The communications link 132 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 128 are capable of implementation on any suitable computing device coupled to the computer network 102, e.g. the controller 108, or the like. The functioning of the server 128 will better be understood in conjunction with the block diagram illustrated in FIG. 7, explained in greater detail below.

Communicatively coupled to the server 128 is the data storage device 130. According to the foregoing example embodiment, the data storage device 130 is any mass storage device, or plurality of such devices, known in the art including, for example and without limitation, magnetic storage drives, a hard disk drive, optical storage devices, flash memory devices, or any suitable combination thereof. In such an embodiment, the data storage device 130 is suitably adapted to store database information, a document management system data, electronic documents, tag data, positioning data, layout data, and the like. It will be appreciated by those skilled in the art that while illustrated in FIG. 1 as being a separate component of the system 100, the data storage device 130 is capable of being implemented as an internal storage component of the server 128, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the computer workstation 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the server 128), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

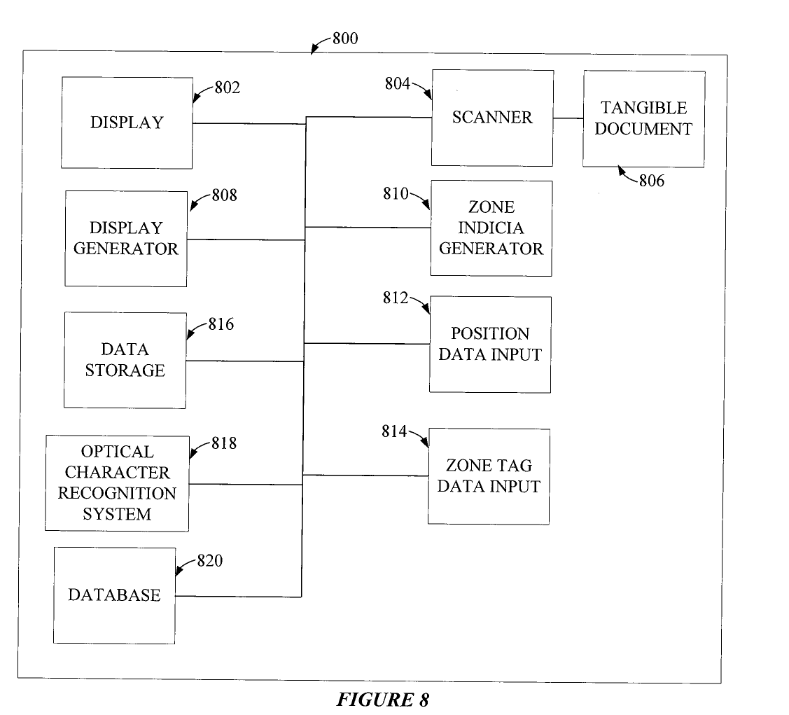

Referring now to FIG. 8, illustrated is a block diagram of a system 800 for setting data extraction fields for scanner input in accordance with one embodiment of the subject application. As shown in FIG. 8, the system 800 includes a display 802 and a scanner 804. Preferably, the scanner 804 is configured to generate electronic document image data from an associated tangible document 806 that has an associated predefined layout. The system 800 further includes a display generator 808 that is capable of generating a document image corresponding to the electronic document image data on the display 802.

Also employed by the system 800 is a zone indicia generator 810, which is operable to generate at least one zone area as a sub-portion, disposed within the document image on the display 802. In addition, the system 800 includes an input 812 that is configured to receive positioning data from an associated user. According to a preferred embodiment of the subject application, the positioning data is representative of a user-selected location of the at least one zone area relative to the electronic document image. A zone tag data input 814 is incorporated into the system 800 and is operable to receive user-selected tag data associated with each of the at least one zone areas.

The system 800 illustrated in FIG. 8 also includes a data storage 816 capable of storing tag data associatively with positioning data based upon a document identifier corresponding to the tangible document 806. In the preferred embodiment of the subject application, the scanner 804 is capable of generating image data corresponding to each of a plurality of tangible documents. Preferably, the predefined layout is associated with each of the plurality of tangible documents from which image data is generated. Also included in the system 800 is an optical character recognition system 818 that is operable to extract character data from image data corresponding to each of the plurality of tangible documents according to the stored positioning data. In addition, the system 800 employs a database 820 that is configured to store the extracted character data from each of the tangible documents associatively with corresponding tag data.

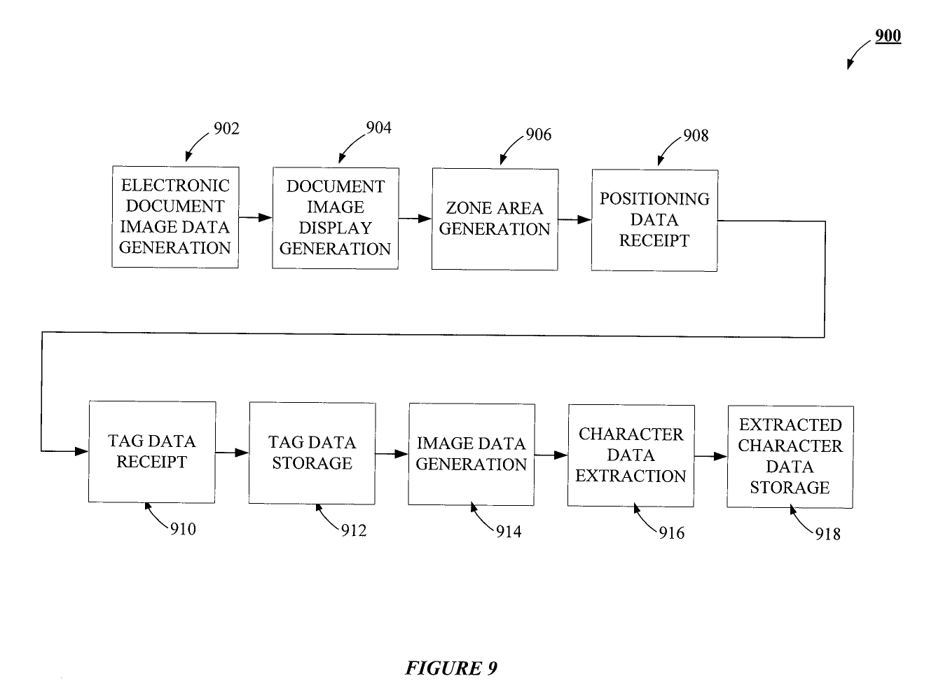

Turning now to FIG. 9, illustrated is a functional diagram of a system 900 for setting data extraction fields for scanner input in accordance with one embodiment of the subject application. As shown in FIG. 9, electronic document image data generation 902 is first performed based upon an associated tangible document having an associated predefined layout. Document image display generation 904 then occurs of the document image data on an associated display. Zone area generation 906 is then performed so as to generate at least one zone area as a sub-portion disposed with the document image on the display.

Positioning data receipt 908 then occurs of positioning data from an associated user. Preferably, the positioning data is representative of a user-selected location of the zone area relative to the electronic document image. Tag data receipt 910 then occurs of user-selected tag data associated with each of the zone areas. Tag data storage 912 is then performed for associatively storing positioning data according to a document identifier corresponding to the tangible document in a data storage. Image data generation 914 is then performed of image data corresponding to each of a plurality of tangible documents, with each of the tangible documents having the predefined layout associated therewith.

Character data extraction 916 is then undertaken of character data from image data corresponding to each the tangible documents in accordance with stored positioning data. Thereafter, extracted character data storage 918 occurs of the extracted character data from each of the tangible documents associatively with corresponding tag data in an associated database.

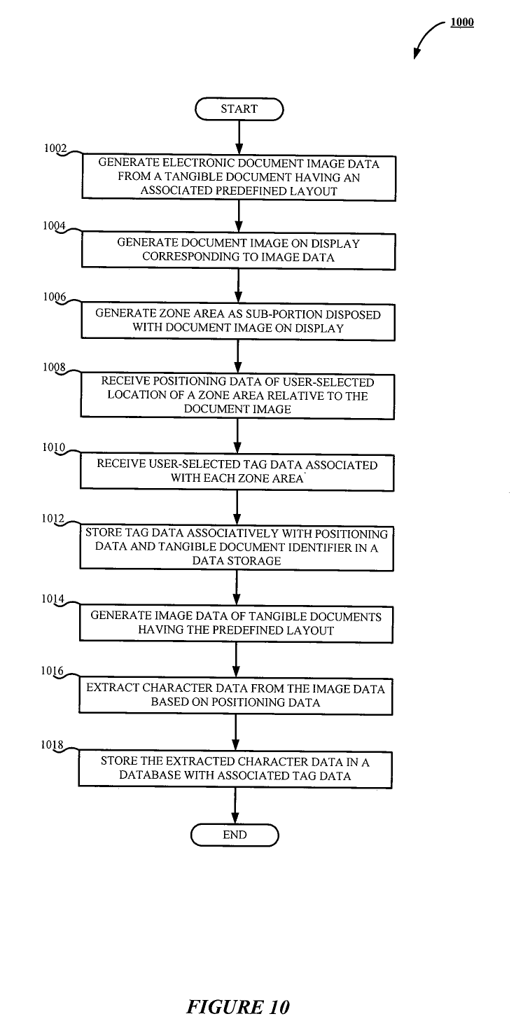

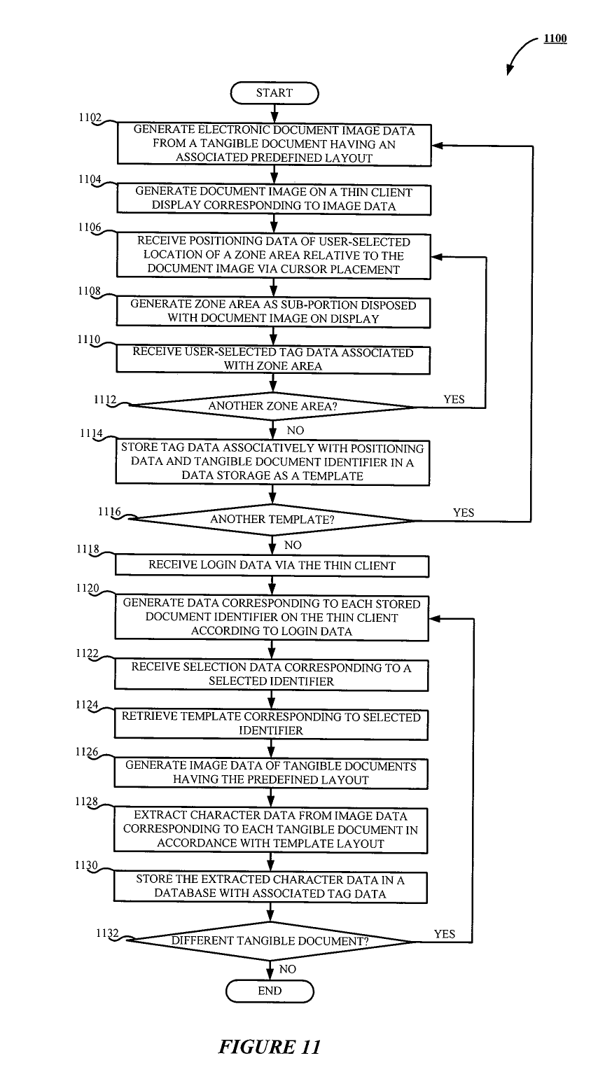

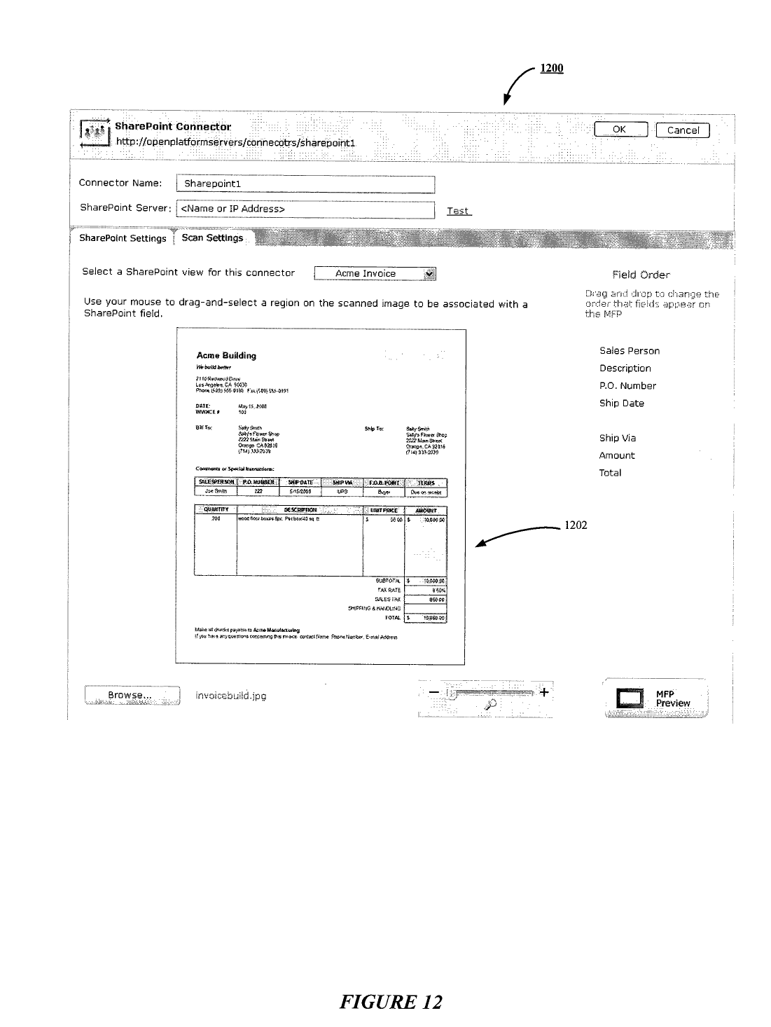

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example illustrations of FIGS. 12-16, discussed in greater detail below. Turning now to FIG. 10, there is shown a flowchart 1000 illustrating a method for setting data extraction fields for scanner input in accordance with one embodiment of the subject application. Beginning at step 1002, electronic document image data is generated from an associated tangible document. In accordance with a preferred embodiment of the subject application, the tangible document has an associated predefined layout. A document image is then generated on an associated display at step 1004, with the image corresponding to the electronic document image data.

At step 1006, at least one zone area is generated as a sub-portion disposed with the document image on the display. In accordance with one embodiment of the subject application, the at least one zone area is representative of a portion of a scanned tangible document that includes extractable data, including, for example and without limitation filled-in parts of a standard form, standard parts of a document (management system identification component), and the like. Positioning data is then received from an associated user at step 1008. According to one embodiment of the subject application, the positioning data represents a user-selected location of the zone area relative to the electronic document image. At step 1010, user-selected tag data associated with each zone area is received from the associated user. The tag data is then associatively stored at step 1012 with the positioning data in accordance with a document identifier of the tangible document in a data storage.

Image data is then generated at step 1014 corresponding to each of a plurality of tangible documents, with each of the tangible documents having the associated predefined layout. At step 1016, character data is extracted from the image data corresponding to each of the tangible documents according to stored positioning data. Thereafter, at step 1018, the character data extracted from each of the tangible documents is stored in association with tag data corresponding to the documents in an associated database.

Referring now to FIG. 11, there is shown a flowchart 1100 illustrating a method for setting data extraction fields for scanner input in accordance with one embodiment of the subject application. The methodology of FIG. 11 begins at step 1102, whereupon the document processing device 104 generates electronic document image data from a tangible document having an associated, predefined layout. Suitable means of generating such image data include, for example and without limitation, scanning operation, image capture operations, and the like. It will be appreciated by those skilled in the art that such a layout includes, for example and without limitation, an order form, a spreadsheet, a receipt, an invoice, a reporting form, or other such document. A document image is then generated via a thin client on the user interface 106, the display 116, the workstation 122, or the like at step 1104 corresponding to the image data generated at step 1102. That is, an associated user is presented with an image of the scanned tangible document via a thin client operative on the user interface 106, the display 116, or the workstation 122.

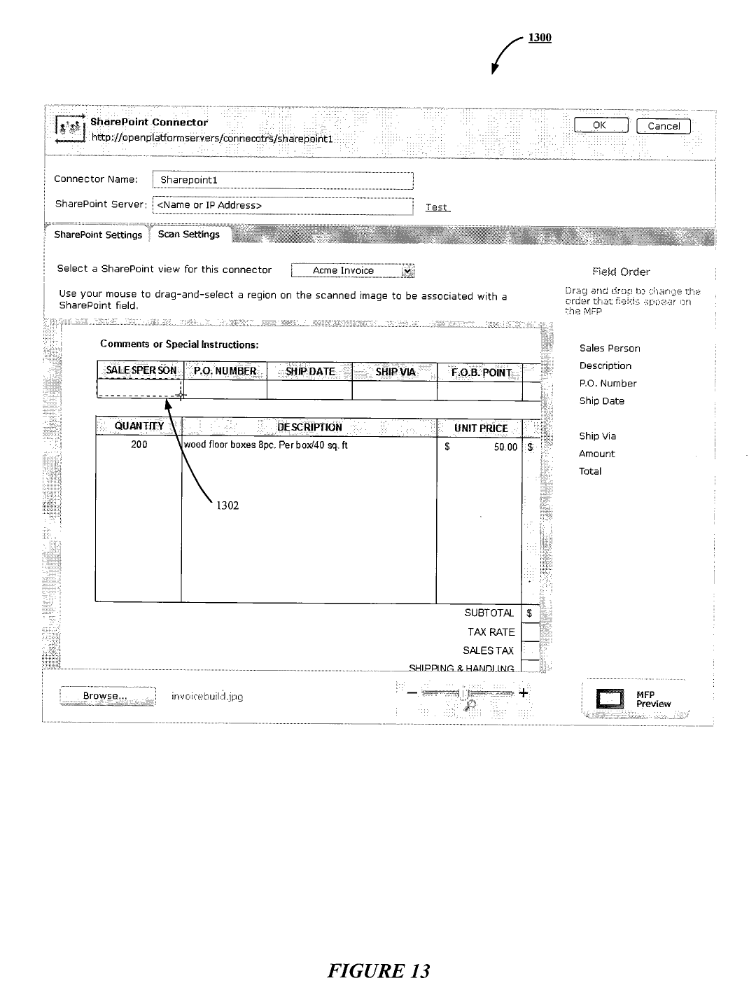

Positioning data of a user-selected location of a zone area relative to the document image displayed via the user interface 106, the display 116, or the workstation 122 is received from the user via cursor placement thereon. In accordance with one embodiment of the subject application, the zone area corresponds to a rectangular box or other such indicia on the display corresponding to a field on the document in which is contained data for collection into the document management system of the server 128. At step 1108, the zone area is generated on the user interface 106, the display 116, or workstation 122 as a sub-portion disposed on the displayed document image. FIG. 12 illustrates an example thin client display 1200 depicting a scanned tangible document 1202 for use in accordance with the methodology of FIG. 11. As shown in FIG. 12, the thin client display 1200 enables the user to select one or more areas for character data extraction, as explained in greater detail below. FIG. 13 depicts the positioning of a user-selected zone area 1302, e.g. a selected input field, on the thin client 1300. It will be appreciated by those skilled in the art that such positioning is capable of being accomplished via a mouse, touch pad, or other similar input device associated with the workstation 122, the kiosk 114, or the user interface 106.

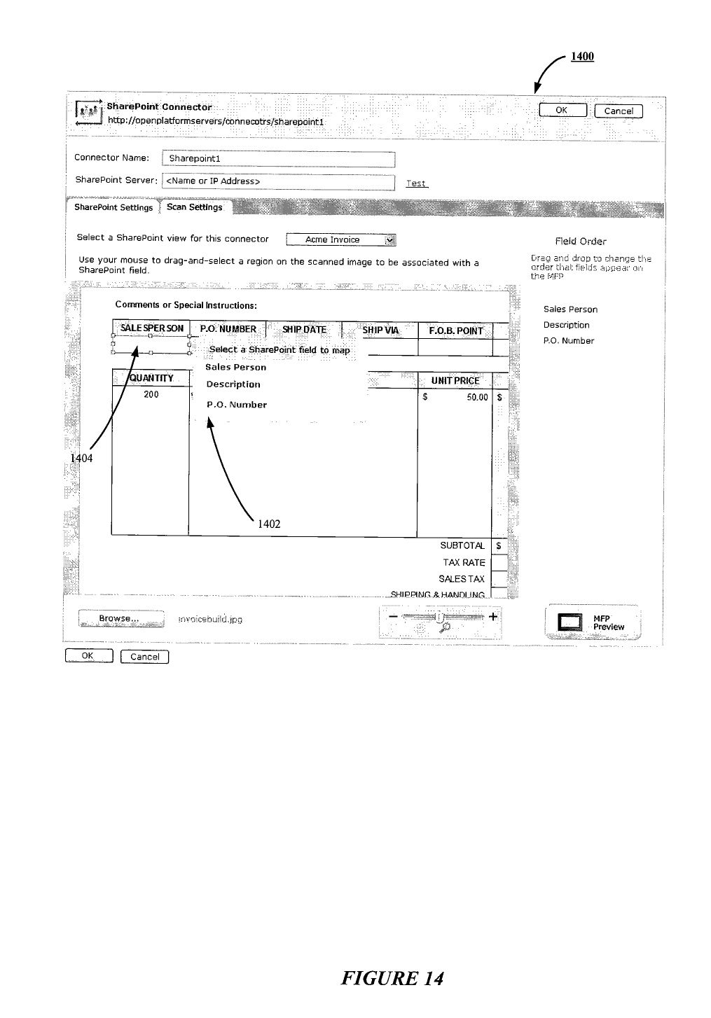

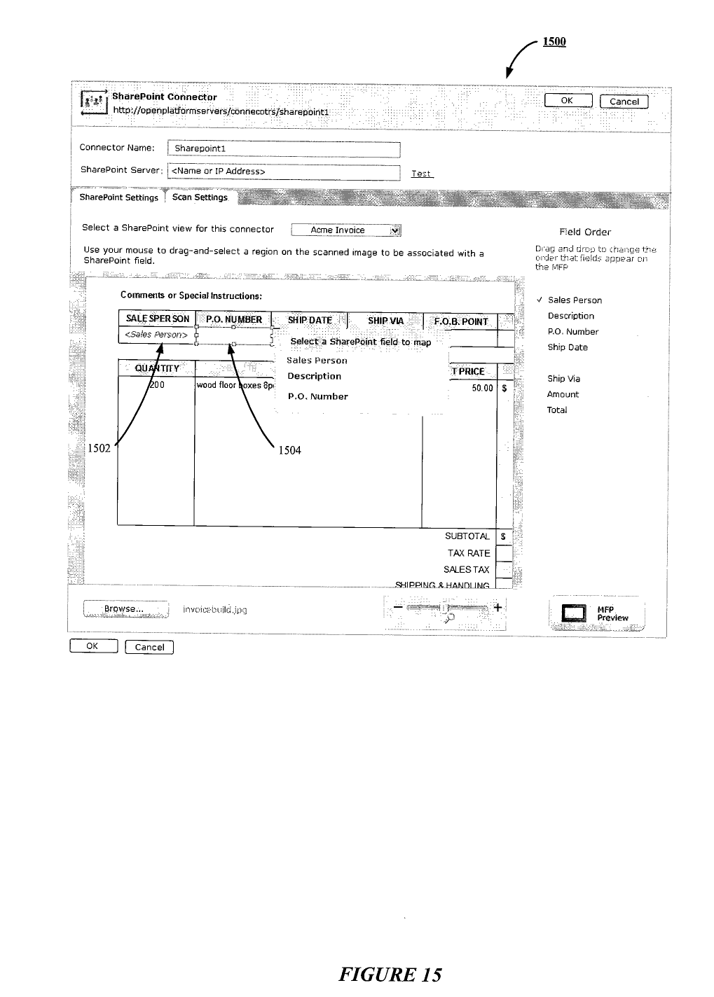

User-selected tag data is then received from the user for association with each zone area at step 1110. According to one embodiment of the subject application, the tag data includes one or more tag identifiers, such as, for example and without limitation, a purchase order number, a serial number, a date, a cost, a time, a quantity, shipping information, an address, and a name. FIG. 14 depicts a thin client 1400 on which is selectable one or more suitable tags 1402 for association with the user-selected zone area 1404. A determination is then made at step 1112 whether another zone area has been selected by the associated user. That is, whether the associated user has selected another field, line, or other area on the scanned document from which data is to be collected. Upon a positive determination at step 1112, operations return to step 1106, whereupon positioning data corresponding to the additional zone area is received. FIG. 15 illustrates a thin client display 1500 via which a first zone area 1502 is displayed indicative of an area from which character data is to be extracted, and the additional zone area 1504 as selected by the user.

When it is determined at step 1112 that no additional zone areas are associated with the document image data, flow progresses to step 1114. At step 1114, the tag data is stored associatively with positioning data and a tangible document identifier in the data storage 130 as a template. It will be appreciated by those skilled in the art that the template is preferably generated in a device-independent language, e.g. eXtensible Markup Language (XML) or the like. In accordance with one embodiment of the subject application, the template is stored in a document management system hosted by the server 128, as will be understood by the skilled artisan.

A determination is then made at step 1116 whether another template is to be created. That is, whether or not the user elects to input another tangible document from which a template is to be created. Upon a positive determination at step 1116, operations return to step 1102, whereupon electronic document image data is generated from a new tangible document for the generation of the new template. Operations then proceed with respect to the new tangible document for the generation of the new template as set forth above in steps 1104 through 1114.

Upon a determination at step 1116 that no additional templates are to be created by the associated user, flow proceeds to step 1118, whereupon login data is received via the thin client of the user interface 106, the display 116, or workstation 122. It will be understood by those skilled in the art that the methodology of FIG. 11 is capable of terminating after step 1116 with respect to an administrative user, and that step 1118 through step 1132 are capable of being accomplished via interactions of an associated user, an administrative user, or the like. Following receipt of the login data, data corresponding to each stored document identifier is generated on the thin client according to the login data at step 1120. According to one embodiment of the subject application, the login data is received via the user interface 106 or kiosk 114 and communicated to the server 128, which correlates the login data with accessible or authorized templates (based upon document identifiers associated therewith). The server 128 then returns such identifiers to the thin client for display to the associated user.

Selection data is then received from the associated user at step 1122 corresponding to a selected identifier, i.e. a desired template. The template corresponding to the selected identifier is then retrieved from the document management system of the server 128 at step 1124 by the controller 108 or other suitable component associated with the document processing device 104. Image data is then generated of tangible documents having the predefined layout associated with the template by the document processing device 104 at step 1126. That is, the document processing device 104 performs a plurality of scans of tangible documents that have the same layout as that of the template, i.e. completed forms to the blank form (template). Character data is then extracted from the image data corresponding to each tangible document in accordance with the template layout at step 1128. The extracted character data is then stored with associated tag data in the database, i.e. the document management system of the server 128, at step 1130. A determination is then made at step 1132 whether a different tangible document, i.e. one that does not conform to the predefined layout of the template, has been scanned by the document processing device 104. Upon a positive determination, operations return to step 1120, whereupon the associated user is prompted to select a suitable template corresponding to the different document. In the event that a different tangible document has not been received, operations with respect to FIG. 11 terminate after step 1132.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for setting data extraction fields for scanner input comprising:
a display;
a scanner operable to generate electronic document image data from an associated tangible document, the tangible document having a predefined layout associated therewith;
a display generator operable to generate a document image corresponding to the electronic document image data on the display;
a zone indicia generator operable to generate at least one zone area as a sub-portion disposed within the document image on the display;
an input operable to receive positioning data from an associated user, the positioning data being representative of a user-selected location of the at least one zone area relative to the electronic document image;
a zone tag data input operable to receive user-selected tag data associated with each of the at least one zone areas;
a data storage operable to store tag data associatively with positioning data in accordance with a document identifier corresponding to the tangible document;
the scanner being further operable to generate image data corresponding to each of a plurality of tangible documents, each of a plurality of tangible documents having the predefined layout associated therewith;
an optical character recognition system operable to extract character data from image data corresponding to each of the plurality of tangible documents in accordance with stored positioning data; and
a database operable to store extracted character data from each of the plurality of tangible documents associatively with tag data corresponding thereto.

2. The system of claim 1 wherein the input is further operable to receive the positioning data in accordance with a cursor placement on the document image.

3. The system of claim 1 wherein the tag data includes at least one tag identifier from a set comprising purchase order number, serial number, date, cost, time, quantity, shipping information, address, and name.

4. The system of claim 2 wherein the display is comprised of a thin client display operable on a workstation in network data communication with the scanner.

5. The system of claim 4 wherein the database is associated with a document management system operable on networked server.

6. The system of claim 4 further comprising:
an input operable to receive login data associated with the thin client;
an output operable to generate, on the thin client, data corresponding to each of a plurality of stored document identifiers in accordance with received login data, wherein each document identifier has a predefined layout associated therewith;
an input operable to receive, from the thin client, selection data corresponding to a selected document identifier; and
wherein the scanner is further operable to extract character data from image data corresponding to each of the plurality of tangible documents in accordance with selection data received via the input.

7. A method for setting data extraction fields for scanner input comprising the steps of:
generating electronic document image data from an associated tangible document, the tangible document having a predefined layout associated therewith;
generating a document image corresponding to the electronic document image data on an associated display;
generating at least one zone area as a sub-portion disposed with the document image on the display;
receiving positioning data from an associated user, the positioning data being representative of a user-selected location of the at least one zone area relative to the electronic document image;
receiving user-selected tag data associated with each of the at least one zone areas;
storing tag data associatively with positioning data in accordance with a document identifier corresponding to the tangible document in a data storage;
generating image data corresponding to each of a plurality of tangible documents, each of a plurality of tangible documents having the predefined layout associated therewith;
extracting character data from image data corresponding to each of the plurality of tangible documents in accordance with stored positioning data; and
storing extracted character data from each of the plurality of tangible documents associatively with tag data corresponding thereto in an associated database.

8. The method of claim 7 further comprising receiving the positioning data in accordance with a cursor placement on the document image.

9. The method of claim 7 wherein the tag data includes at least one tag identifier from a set comprising purchase order number, serial number, date, cost, time, quantity, shipping information, address, and name.

10. The method of claim 7 wherein the display is generated as a thin client display on a workstation in network data communication with the scanner.

11. The method of claim 7 wherein the database is associated with a document management system operable on networked server.

12. The method of claim 10 further comprising the steps of:
receiving login data via the thin client;
generating, on the thin client, data corresponding to each of a plurality of stored document identifiers in accordance with received login data, wherein each document identifier has a predefined layout associated therewith;
receiving, from the thin client, selection data corresponding to a selected document identifier; and
extracting character data from image data corresponding to each of the plurality of tangible documents in accordance with received selection data.

13. A system for setting data extraction fields for scanner input comprising:
a display;
means adapted for generating electronic document image data from an associated tangible document, the tangible document having a predefined layout associated therewith;
means adapted for generating a document image corresponding to the electronic document image data on the display;
zone indicia generator means adapted for generating at least one zone area as a sub-portion disposed with the document image on the display;
means adapted for receiving positioning data from an associated user, the positioning data being representative of a user-selected location of the at least one zone area relative to the electronic document image;
zone tag data input means adapted for receiving user-selected tag data associated with each of the at least one zone areas;
a data storage means for storing tag data associatively with positioning data in accordance with a document identifier corresponding to the tangible document;
means adapted for generating image data corresponding to each of a plurality of tangible documents, each of a plurality of tangible documents having the predefined layout associated therewith;
means adapted for extracting character data from image data corresponding to each of the plurality of tangible documents in accordance with stored positioning data; and
means adapted for storing extracted character data from each of the plurality of tangible documents associatively with tag data corresponding thereto in an associated database.

14. The system of claim 13 further comprising means adapted for receiving the positioning data in accordance with a cursor placement on the document image.

15. The system of claim 13 wherein the tag data includes at least one tag identifier from a set comprising purchase order number, serial number, date, cost, time, quantity, shipping information, address, and name.

16. The system of claim 13 wherein the display is comprised of a thin client display operable on a workstation in network data communication with the scanner.

17. The system of claim 13 wherein the database is associated with a document management system operable on networked server.

18. The system of claim 16 further comprising:
means adapted for receiving login data via the thin client;
means adapted for generating, on the thin client, data corresponding to each of a plurality of stored document identifiers in accordance with received login data, wherein each document identifier has a predefined layout associated therewith;
means adapted for receiving, from the thin client, selection data corresponding to a selected document identifier; and
means adapted for extracting character data from image data corresponding to each of the plurality of tangible documents in accordance with received selection data.
